(19) United States
(12) Patent Application Publication
(10) Pub. No.: US 2011/0001886 A1
(43) Pub. Date: Jan. 6, 2011

(54) CARRIER TRACKING SYSTEM AND METHOD

(76) Inventor: Tien-Ju Tsai, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/496,634

(22) Filed: Jul. 1, 2009

(51) Int. Cl. H04N 5/50

(52) U.S. Cl. 348/731; 348/E05.097

(57) ABSTRACT

A system for tracking a tone (carrier) within a frequency range is provided. The carrier tracking system includes a complex frequency down-converter, a waveform generator, a coordinate converter, and a control circuit. The frequency down-converter generates a Cartesian signal by mixing an input signal and sine and cosine signals. The waveform generator generates the sine and cosine signals based on a frequency bias signal. The coordinate converter converts the Cartesian signal into a polar signal having a norm signal and a phase signal. The control circuit selects a candidate frequency within a predetermined frequency range based on the norm signal and a estimated frequency deviation corresponding to the candidate frequency based on the phase signal, and generates the frequency bias signal based on the candidate frequency, the estimated frequency deviation and a loop error determined by the phase signal.

### BACKGROUND OF THE INVENTION

1. Field of the Invention

The present invention relates to tracking a tone within a frequency range, in particular, to a carrier tracking system and method for tracking a tone with a maximum power within a predetermined frequency range.

2. Description of the Prior Art

In traditional analog TV broadcasting systems (e.g., NTSC, PAL, or SECAM) or digital TV broadcasting systems (e.g., ATSC, DVB-T, or SVB-TH), video and audio baseband signals are first modulated to become modulated intermediate frequency (IF) signals according to corresponding modulation (e.g., AM, FM, QPSK, QAM, or OFDM) and channel bandwidth specifications, and then the modulated IF signals are filtered, frequency up-converted, and amplified to become modulated radio frequency (RF) signals according to corresponding specifications. Finally, the modulated RF signals are coupled into air via antenna or conducted to coaxial transmission cables.

For example, in an NTSC system, an image baseband signal is first low-pass-filtered at 4.2 MHz and then amplitude-modulated to an IF signal at 45.75 MHz and filtered via a VSB shaping filter; besides, an audio baseband signal is first encoded via multi-channel television sound (MTS), low-pass-filtered at 100 kHz, and then frequency-modulated to an IF carrier at 41.25 MHz. Therefore the modulated IF signals of video and audio are mixed, filtered via a band-pass filter with a central frequency of 44 MHz and a bandwidth of 6 MHz, up-converted and then amplified to become an RF signal.

At the receiving end, the RF signals coupled via an antenna or a coaxial transmission cable are sent to a tuner for processing. Since the received RF signals are wideband in frequency (50 MHz-1 GHz), the tuner processes and demodulates the received RF signals with a specific radio frequency to recover the original video and audio signals carried by the received RF signals. Generally speaking, to facilitate a synchronization of carriers at the receiving end, a tone-like signal with a relatively large power, for example, a video carrier in the NTSC system, is allocated within a predetermined bandwidth. However, in order to avoid frequency bands which have many interference sources, channel frequencies might be intentionally adjusted (usually shifted by 1-2 MHz) to achieve a better reception. Under the condition that the receiving end is not notified about the frequency adjustment in advance, the receiving end is required to synchronize the newly adjusted channel frequency properly and quickly when executing channel sweeping (scanning) or channel alternation. Therefore, an accurate and quick carrier synchronization mechanism is required.

In addition, in some applications that require pattern identification, e.g., audio signal processing or image identification, it is usually necessary to search for a specific signal with a relatively large power within an incoming wideband signal. Thus, an accurate and quick searching synchronization mechanism is necessary.

In the prior art, a phase-lock loop (PLL) is often utilized to search and synchronize a carrier or a tone-like signal with relatively high power within a specific frequency range. However, a conventional PLL is hardly capable of fulfilling the aforementioned requirement due to a long settling time or incapability of tracking and synchronizing to the carrier or the tone-like signal.

### SUMMARY OF THE INVENTION

The present invention brings out a carrier tracking system and method for searching and synchronizing a tone-like signal (a carrier or a tone) with a maximum power within a predetermined frequency range quickly and accurately.

According to one aspect of the present invention, a carrier tracking system for tracking a tone with a maximum power within a frequency range is provided. The carrier tracking system includes a complex frequency down-converter, a waveform generator, a coordinate converter, and a control circuit. The frequency down-converter generates a Cartesian signal by mixing an input signal and sine and cosine signals. The waveform generator generates the sine and cosine signals based on a frequency bias signal. The coordinate converter converts the Cartesian signal into a polar signal having a norm signal and a phase signal. The control circuit selects a candidate frequency within a predetermined frequency range based on the norm signal and a estimated frequency deviation corresponding to the candidate frequency based on the phase signal, and generates the frequency bias signal based on the candidate frequency, the estimated frequency deviation and a loop error determined by the phase signal.

According to another aspect of the present invention, a method for tracking a tone within a frequency range is provided. The method includes: generating a Cartesian signal by mixing an input signal and sine and cosine signals; generating the sine and cosine signals based on a frequency bias signal; converting the Cartesian signal into a polar signal having a norm signal and a phase signal; estimating the power of the input signal at a plurality of candidate frequencies within the predetermined frequency range based on the norm signal; estimating frequency deviations of the input signal at the plurality of candidate frequencies; selecting a candidate frequency at which the maximum power of the input signal is estimated and a frequency deviation corresponding to the candidate frequency at which the maximum power of the input signal is estimated; and generating the frequency bias signal based on the candidate frequency, the estimated frequency deviation and a loop error determined by the phase signal, where the loop error is generated based on the phase signal when the candidate frequency at which the maximum power of the input signal is estimated and the frequency deviation corresponding to the candidate frequency at which the maximum power of the input signal is estimated are selected.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a carrier tracking system for tracking and synchronizing a tone-like signal with a maximum power within a predetermined frequency range according to an embodiment of the present invention.

FIG. 2 is a diagram illustrating an operation of a control circuit as a finite state machine according to an embodiment of the present invention.

FIG. 3 is a circuit diagram illustrating an exemplary implementation of a frequency discriminator shown in FIG. 1.

FIG. 4 is a diagram illustrating an operation of a tone arbitrator according to an embodiment of the present invention.

FIG. 5 is a diagram illustrating a distribution of an interfering false signal and an input signal within a plurality of candidate frequencies.

FIG. 6 is a flowchart of a rough frequency estimation process according to the present invention.

FIG. 7 is a diagram illustrating an exemplary circuit configured for generating an average of the frequency deviation and a variance of the frequency deviation within a predetermined time period.

FIG. 8 is a diagram illustrating an exemplary circuit configured for checking whether the frequency deviation passes the criterion check.

FIG. 9 is a diagram illustrating an exemplary circuit configured for checking whether the power passes the criterion check.

FIG. 10 is a circuit diagram illustrating an exemplary implementation of a loop filter shown in FIG. 1.

FIG. 11 is a diagram illustrating an exemplary circuit for the tone arbitrator in FIG. 1 to select output signal.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” The terms “couple” and “couples” are intended to mean either an indirect or a direct electrical connection. Thus, if a first device couples to a second device, that connection may be through a direct electrical connection, or through an indirect electrical connection via other devices and connections.

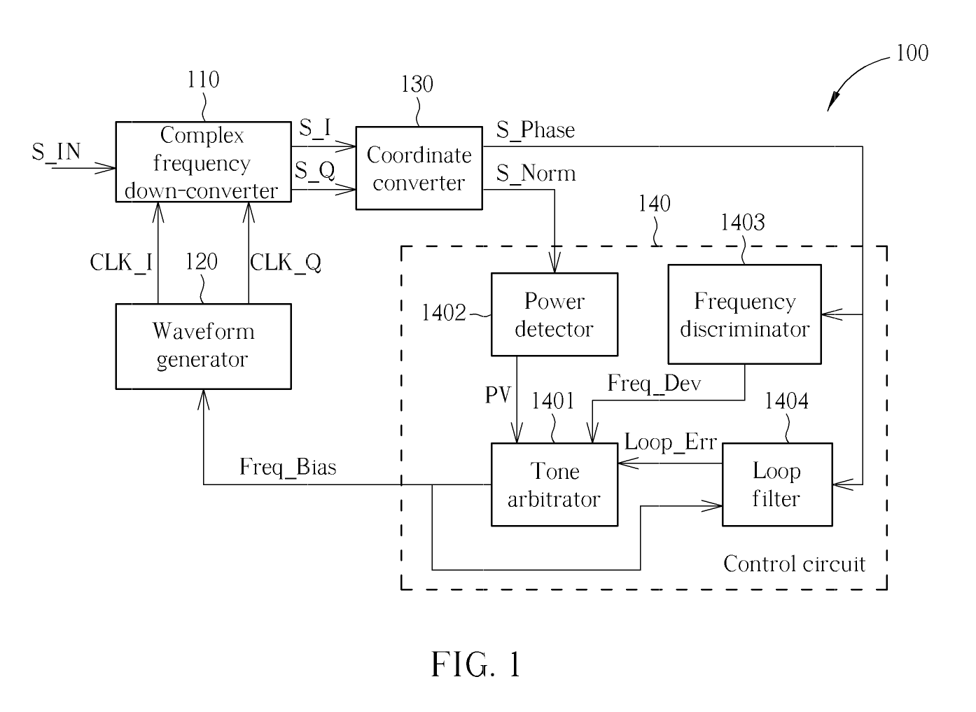

Please refer to FIG. 1. FIG. 1 is a block diagram illustrating a carrier tracking system 100 for tracking and synchronizing a tone-like signal with a maximum power within a predetermined frequency range according to an embodiment of the present invention. The carrier tracking system 100 includes, but is not limited to, a complex frequency down-converter 110, a waveform generator 120, a coordinate converter 130, and a control circuit 140. Please note that only the components pertinent to the present invention are shown in FIG. 1 for simplicity and clarity. The complex frequency down-converter 110 is implemented to perform a complex frequency down-conversion for mixing an input signal S_IN and an in-phase sinusoidal signal CLK_I (e.g., a cosine wave signal) to generate a real part signal S_I, and mixing the input signal S_IN and a quadrature sinusoidal signal CLK_Q (e.g., a sine wave signal) to generate an imaginary part signal S_Q (it should be noted that the real part and the imaginary part signals S_I and S_Q are quadrature in phase). For example, in one exemplary implementation, the complex frequency down-converter 110 is implemented using a conventional complex mixer and a conventional complex low-pass filter. The waveform generator 120 is coupled to the complex frequency down-converter 110, and implemented for receiving a frequency bias signal Freq_Bias and generating the in-phase sinusoidal signal CLK_I and the quadrature sinusoidal signal CLK_Q according to the frequency bias signal Freq_Bias. As the complex frequency down-converter 110 and the waveform generator 120 can be realized using any conventional approaches, further description is omitted here for brevity. In addition, the waveform generator 120 can be a Numerical Controlled Oscillator (NCO)

The coordinate converter 130 is coupled to the complex frequency down-converter 110, and implemented for converting the real part signal S_I and the imaginary part signal S_Q in Cartesian coordinate into a converted result in polar coordinate, wherein the converted result comprises a norm signal S_Norm and a phase signal S_Phase. For example, a complex signal S_I+j*S_Q in Cartesian coordinate is converted by the coordinate converter 130 into S_Norm*êj*S_Phase in polar coordinate. Specifically, the coordinate conversion can be expressed as follows:

$$S\_I + j * S\_Q ≅ \frac{S\_Norm}{1.64674} * {e}^{j 2 π * S\_Phase} \qquad ( 1 )$$

In one exemplary implementation, a CORDIC iteration algorithm is employed by the coordinate converter 130 to derive the norm signal S_Norm and the phase signal S_Phase according to the real part signal S_I and the imaginary part signal S_Q. However, this is for illustrative purposes only, and is not meant to be a limitation to the scope of the present invention.

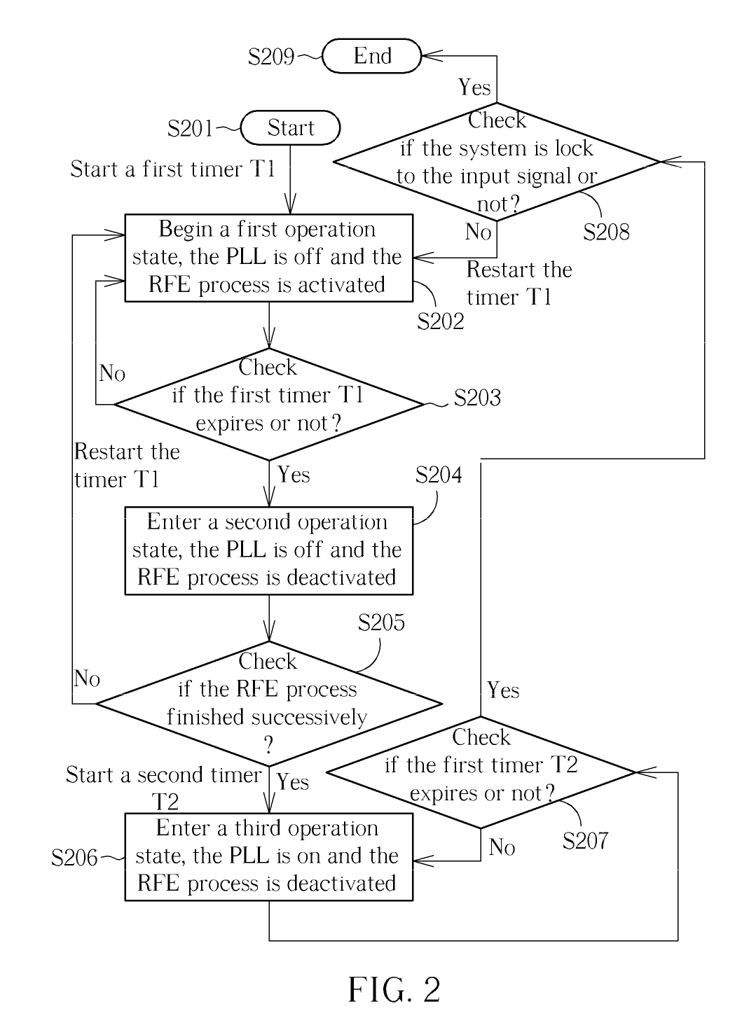

The control circuit 140 is coupled to the coordinate converter 130 and the waveform generator 120, and implemented for determining the frequency bias signal Freq_Bias according to the converted result including the norm signal S_Norm and the phase signal S_Phase. The operation of control circuit 140 can be manifested by a finite state machine as shown in FIG. 2.

S201: Start.

S202: Begin a first operation state S1. Therefore, the PLL is off and a rough frequency estimation (RFE) process starts.

S203: Check if the first timer T1 expires or not. If yes, go to step S204; otherwise, go back to step S202.

S204: Enter a second operation state S2. Therefore, the PLL is off.

S205: Check if the RFE process is finished successively. If yes, go to step S206 and start a second timer T2 simultaneously; otherwise, go back to step S202.

S206: Enter a third operation state S3. Therefore, the PLL is on and the RFE process is finished.

S207: Check if the second timer T2 expires or not. If yes, go to step S208; otherwise, go back to step S206.

S208: Check if the PLL is locked to the input signal or not. If yes, go to step S209; otherwise, go back to step S202.

In the beginning of the first operation state S1, a first timer T1 is started, and meanwhile a RFE process is also started. When the first timer T1 expires, the finite state machine thereby enters a second operation state S2. In the second operation state S2, the control circuit 140 determines whether the RFE process is successfully finished or not. If the RFE process is successfully finished, the finite state machine enters a third operation state S3; otherwise, the finite state machine returns to the first operation state S1 to start once again. In the beginning of the third operation state S3, a second timer T2 is started and the carrier tracking system 100 functions as a closed-loop PLL to begin a locking process by an initial frequency according to the estimation result derived in the first operation state S1, wherein the second timer T2 should be set long enough to assure a stabilized state of the closed-loop PLL. When the second timer T2 expires, the control circuit 140 determines whether the closed-loop PLL is locked to the input signal or not. If the closed-loop PLL is locked to the input signal, the operation of the finite state machine comes to an end; otherwise, the finite state machine returns to the first operation state S1 to start once again.

In addition, in this exemplary embodiment the control circuit 140 comprises a tone arbitrator 1401, a power detector 1402, a frequency discriminator 1403 and a loop filter 1404. The power detector 1402, respectively, estimates the power values of the input signal S_IN at a plurality of candidate frequencies within the predetermined frequency range based on the norm signal S_Norm. The frequency discriminator 1403 estimates frequency deviations Freq_Dev of the input signal S_IN at the plurality of candidate frequencies. The tone arbitrator 1401 selects a candidate frequency within the predetermined frequency range based on the norm signal S_Norm and an estimated frequency deviation Freq_Dev corresponding to the candidate frequency based on the phase signal S_Phase. The loop filter 1404 generates a loop error Loop_Err based on the phase signal S_Phase when the candidate frequency at which the maximum power value PV of the input signal S_IN is estimated and the frequency deviation Freq_Dev corresponding to the candidate frequency at which the maximum power value PV of the input signal S_IN is estimated are selected. Then, the tone arbitrator 1401 generates the frequency bias signal Freq_Bias based on the candidate frequency, the estimated frequency deviation Freq_Dev and the loop error Loop_Err determined by the phase signal S_Phase.

In the first operation state S1, the tone arbitrator 1401 controls the frequency bias signal Freq_Bias according to a plurality of candidate frequencies within the predetermined frequency range, respectively. The power detector 1402 estimates a power value PV of the input signal S_IN at each of the candidate frequencies in the first operation state S1 according to the norm signal S_Norm. Specifically, the power value PV can be expressed as follows:

$$PV = {lim}_{T ∞} \frac{1}{T} {\int }_{- T / 2}^{T / 2} {\vert S\_Norm ( t ) \vert}^{2} d t \qquad ( 2 )$$

The power detector 1402 is therefore used to find an estimated value substantially equal to or close to the power function expressed in equation (2). In one exemplary implementation, the power detector 1402 is implemented using a low-pass filter to perform a low-passing filtering upon the norm signal S_Norm to estimate one power value PV of the input signal S_IN at each of the candidate frequencies in the first operation state S1; in another exemplary implementation, a maximum value of the norm signal S_Norm is found during a predefined period for estimating one power value PV of the input signal S_IN at each of the candidate frequencies in the operation state S1.

The tone arbitrator 1401 selects a candidate frequency (i.e., a specific candidate frequency) from the plurality of candidate frequencies within the predetermined frequency range, where the selected candidate frequency corresponds to a maximum power value PV selected from the power values PV of the input signal S_IN at the plurality of candidate frequencies. The frequency discriminator 1403 determines a frequency deviation Freq_Dev according to the phase signal S_Phase. Specifically, the frequency deviation Freq_Dev can be expressed as follows:

$$Freq\_Dev = \frac{1}{2 * π} \times \frac{\partial S\_Phase ( t )}{\partial t} \qquad ( 3 )$$

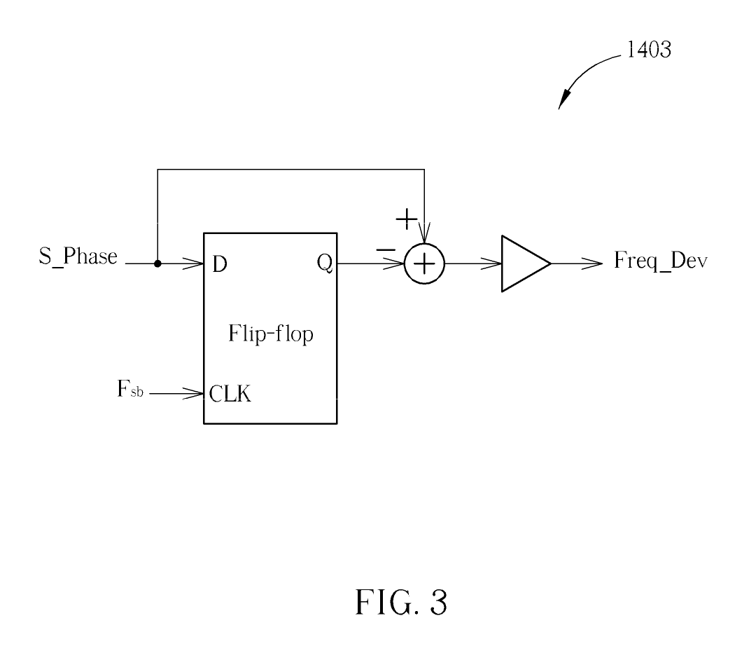

The frequency discriminator 1403 is therefore used to find an estimated value substantially equal to or close to the frequency deviation Freq_Dev expressed in equation (3). An exemplary implementation of the frequency discriminator 1403 is shown in FIG. 3. As a person skilled in the art should be able to readily understand the operation of the circuitry shown in FIG. 3 after reading the above description, further description directed to the exemplary implementation in FIG. 3 is omitted here for brevity. The tone arbitrator 1401 further selects an estimated frequency deviation Freq_Dev corresponding to the selected candidate frequency.

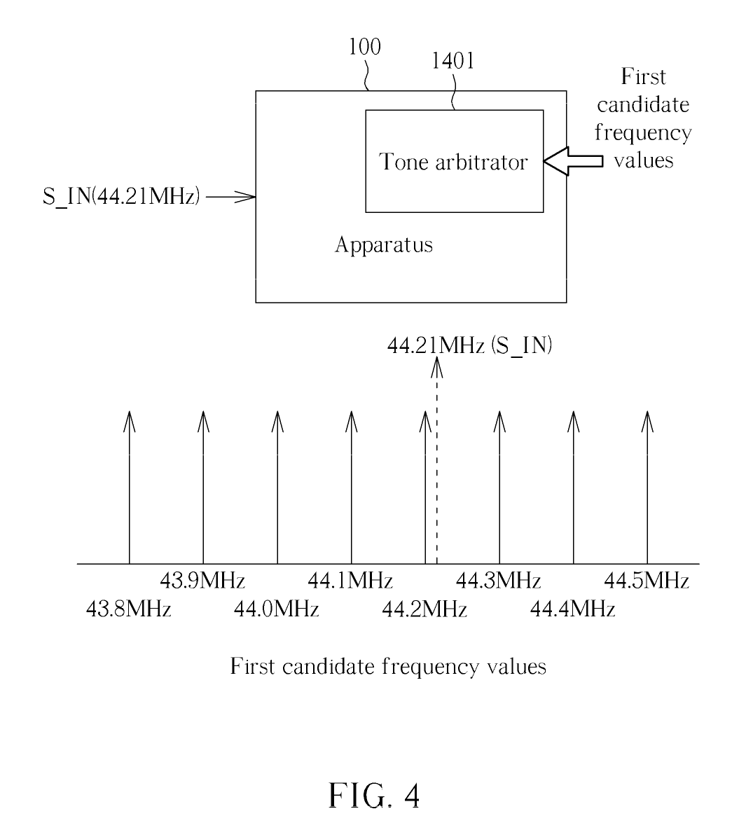

Please refer to FIG. 4 to have a more detailed comprehension of the operation of the tone arbitrator 1401. FIG. 4 is a diagram illustrating an operation of the tone arbitrator 1401 according to an embodiment of the present invention. In the first operation state S1 (i.e., during the RFE process), the tone arbitrator 1401 is fed sequentially with a plurality of candidate frequencies which are distributed within a predetermined frequency range with a predetermined step size. For example, in FIG. 4, the candidate frequencies are distributed from 43 MHz to 47 MHz with a step size of 100 kHz. In this example, the tone arbitrator 1401 is thereby fed first with a candidate frequency of 43 MHz, and then 43.1 MHz, 43.2 MHz, and so on, until the last candidate frequency, i.e., 47 MHz, is fed to the tone arbitrator 1401. While feeding the tone arbitrator 1401 with the candidate frequencies sequentially, the power detector 1402 also estimates each power value PV corresponding to each of the candidate frequencies sequentially according to the corresponding norm signal S_Norm. And the tone arbitrator 1401 determines a target frequency for the frequency bias signal Freq_Bias according to a plurality of power values respectively corresponding to the candidate frequencies at the end of the first operation state S1.

In this embodiment, since the objective is to find a tone or a carrier with a maximum power within a predetermined frequency range, the tone arbitrator 1401 therefore picks a specific candidate frequency from the candidate frequencies, and the estimated power value PV of the input signal S_IN at the specific candidate frequency is larger than the estimated power value PV of the input signal S_IN at other candidate frequency. In more detail, the specific candidate frequency is the closest to the tone (or the carrier) than other candidate frequencies.

For example, in FIG. 4, the input signal S_IN is at a frequency 44.21 MHz and the carrier tracking system 100 is to find a tone having a maximum power within a predetermined frequency range from 43 MHz to 47 MHz. Assuming a frequency step of 100 kHz is adopted, the tone arbitrator 1401 within the carrier tracking system 100 is fed with a plurality of candidate frequencies from 43 MHz to 47 MHz with a step of 100 kHz, respectively and sequentially. During the first operation state S1, the power detector 1402 estimates a maximum power value of the input signal S_IN at a candidate frequency of 44.2 MHz since it is the closest to the frequency of the input signal S_IN, and thereby the frequency 44.2 MHz is chosen as the specific candidate frequency. Furthermore, the tone arbitrator 1401 determines the frequency offset value, e.g., an average of the frequency deviation Freq_Dev within a predetermined time period at the candidate frequency of 44.2 MHz, according to the frequency deviation Freq_Dev determined from the frequency discriminator 1403. The tone arbitrator 1401 thereby determines the target frequency according to the frequency offset value and the specific candidate frequency of 44.2 MHz. In this way, after the RFE process is successively finished, the waveform generator 120 is able to output signals at a frequency very close to the input frequency, i.e., 44.21 MHz. It should be noted that the accuracy of the target frequency is only slightly related to the adopted step size, adopting a larger step size leads to almost no degradation to the accuracy of the derived target frequency but a more effort of the circuit design (e.g., the filter within the complex frequency down-converter 110 and complexity of the coordinate converter 130).

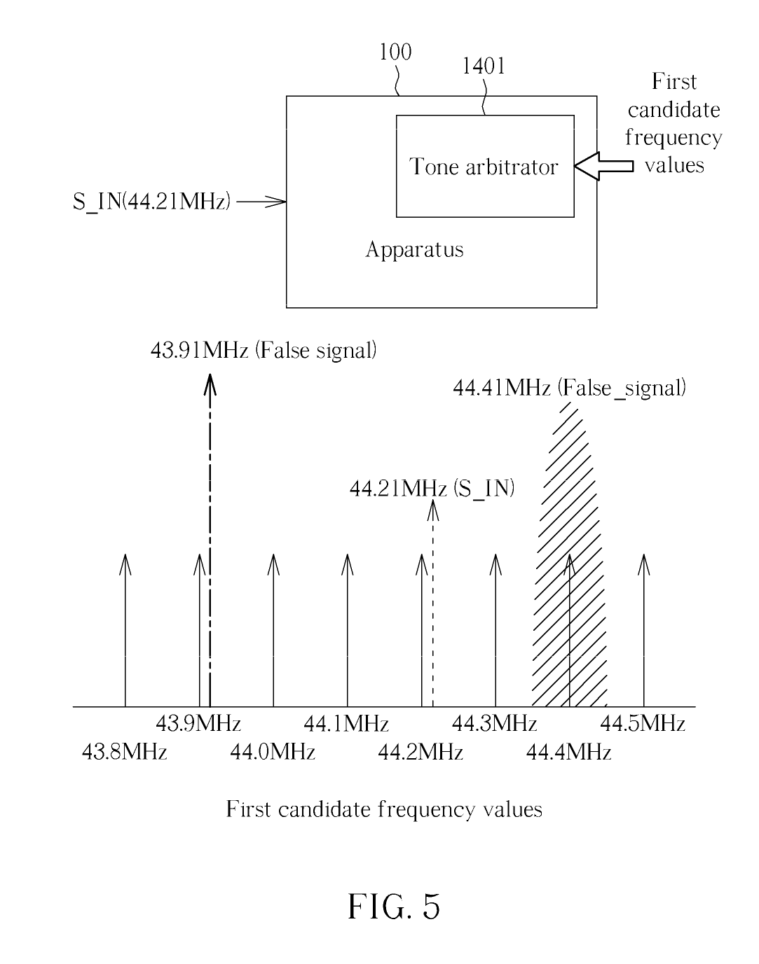

However, some constraints must be put before determining the target frequency. On one hand, Doppler effect and multi-path fading might seriously degrade the received signal and leads to an unstable connection; on the other hand, as shown in FIG. 5, a false signal, e.g., a noise signal or an interfering signal, which only exists for a very short period, appears at 43.91 MHz with a very large power. On the other hand, the false signal may also be a frequency-modulated signal (e.g., a QPSK signal) which has a large but not tone-like power at 44.41 MHz. Assuming the power detector 1402 detects the false signal during the RFE process and the tone arbitrator 1401 determines the specific candidate frequency at 43.9 MHz or 44.4 MHz and thereby sets a target frequency around 43.91 MHz or 44.41 MHz rather than 44.21 MHz. Consequently, the output signals generated from the waveform generator 120 will also be false, leading to an error in this mechanism. Therefore, certain criteria must be implemented upon power and phase detection to assure the accuracy of the target frequency.

In order to avoid the undesired false signal detection, certain predetermined criteria must be put upon the frequency deviation Freq_Dev and the power value PV of the input signal S_IN. In this embodiment, the tone arbitrator 1401 further processes the frequency deviation Freq_Dev to derive an average of the frequency deviation Freq_Dev and a variance of the frequency deviation Freq_Dev. In the first operation state S1, the power value PV corresponding to the specific candidate frequency must exceed a power threshold; meanwhile, the average of the frequency deviation Freq_Dev and the variance of the frequency deviation Freq_Dev corresponding to the specific candidate frequency are examined whether they satisfy the predetermined criteria (i.e., the average of the frequency deviation Freq_Dev and the variance of the frequency deviation Freq_Dev do not exceed an average threshold and a variance threshold, respectively). The tone arbitrator 1401 sets the target frequency by a default frequency when the power value PV corresponding to the specific candidate frequency does not exceed the power threshold or the frequency deviation Freq_Dev do not satisfies the aforementioned predetermined criteria; and the tone arbitrator 1401 sets the target frequency by an adjusted candidate frequency (i.e., the frequency offset value plus the specific candidate frequency) when the power value PV corresponding to the specific candidate frequency exceeds the power threshold and the frequency deviation Freq_Dev satisfies the aforementioned predetermined criteria.

In the second operation state S2, given that the aforementioned criteria are all fulfilled and the target frequency is set to be the adjusted candidate frequency (i.e., the frequency offset value plus the specific candidate frequency), the power value PV corresponding to the adjusted candidate frequency and the frequency deviation Freq_Dev corresponding to the adjusted candidate frequency thereof still have to fulfill certain criteria to ensure proper detection. For example, the carrier tracking system 100 in FIG. 4 receives an input signal S_IN of 44.21 MHz and the tone arbitrator 1401 within the carrier tracking system 100 will determine the target frequency having a very tiny difference from the input signal S_IN. The tone arbitrator 1401 will then determine whether the power value PV corresponding to the adjusted candidate frequency exceeds a second power threshold which is derived from the power value PV according to the specific candidate frequency and whether the corresponding average of the frequency deviation Freq_Dev and the corresponding variation of the frequency deviation Freq_Dev satisfy the predetermined criteria. In this way, the tone arbitrator 1401 is able to ensure that the RFE process is successfully finished. Otherwise, assuming that there is an interfering false signal of 43.91 MHz or 44.41 MHz as shown in FIG. 5, the tone arbitrator 1401 determines that the target frequency as a frequency close to 43.91 MHz or 44.41 MHz rather than 44.21 MHz, the power value PV and the frequency deviation Freq_Dev corresponding to the false target frequency, i.e., 43.91 MHz or 44.41 MHz, cannot fulfill the criteria mentioned above since the false signal is unstable or variant in phase domain. As a result, the tone arbitrator 1401 determines that the RFE process fails and restarts another RFE process. In addition, applying those criteria check also helps to avoid Doppler effect and multi-path fading, leading to assuring a better connection quality.

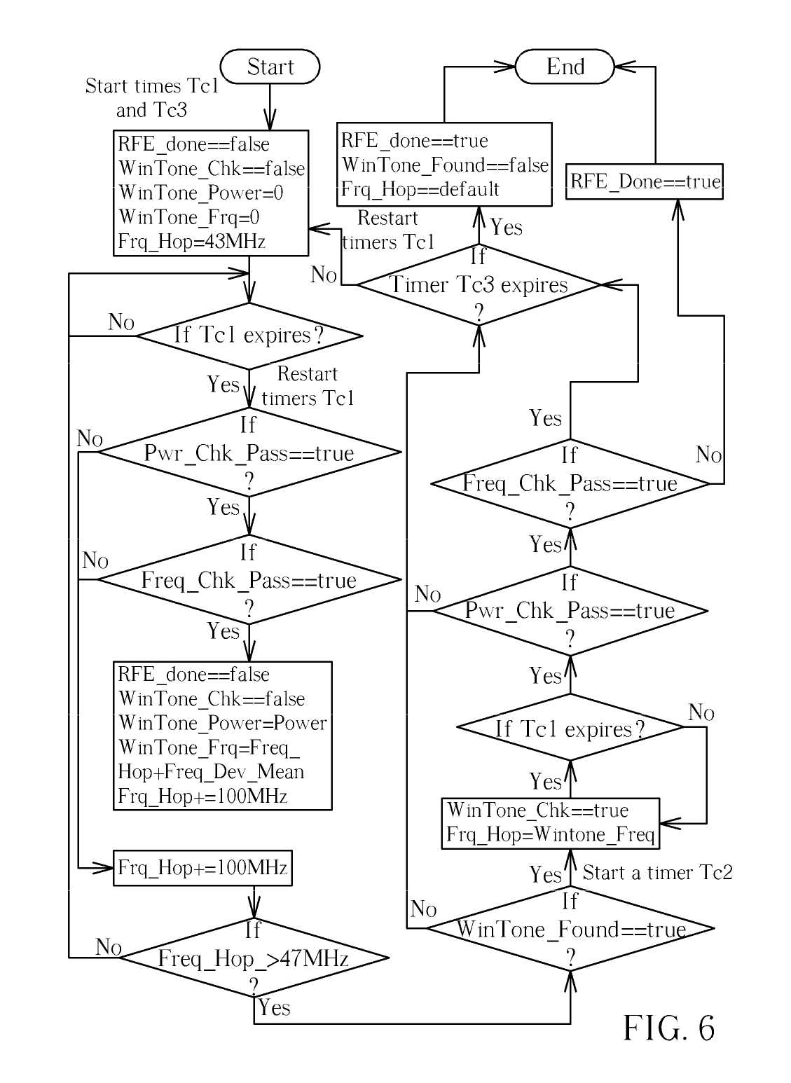

Please refer to FIG. 6, FIG. 6 illustrates one exemplary flowchart of RFE process according to the present invention, as a person skilled in the art can readily understand the operation of the circuitry shown in FIG. 6 after reading above description. The carrier tracking system 100 is used to find a maximum tone within a predetermined frequency range from 43 MHz to 47 MHz with a predetermined frequency step of 100 kHz. First of all, in the first operation state S1, the tone arbitrator 1401 within the carrier tracking system 100 is fed with a sinusoidal signal of 43 MHz, the power detector 1402 estimates a power value at the candidate frequency of 43 MHz and the frequency discriminator 1403 further determines an average of the frequency deviation Freq_Dev (i.e., Freq_Dev_Mean in FIG. 6) and a variance of the frequency deviation Freq_Dev at the candidate frequency of 43 MHz. Since 43 MHz is the first one fed to the carrier tracking system 100, the tone arbitrator 1401 sets the power value at 43 MHz as WinTone_Power (a power threshold) and sets the average of the frequency deviation Freq_Dev at 43 MHz plus the candidate frequency of 43 MHz as WinTone_Freq. In the next iteration, a sinusoidal signal of 43.1 MHz is fed; the power detector 1402 estimates a power value at the candidate frequency of 43.1 MHz and the tone arbitrator 1401 checks that whether the power value at 43.1 MHz exceeds the previously documented threshold WinTone_Power. Then the tone arbitrator 1401 checks that whether the average of the frequency deviation Freq_Dev and the variance of the frequency deviation Freq_Dev at 43.1 MHz pass the predetermined criteria. If all the aforementioned criteria are fulfilled at 43.1 MHz, the candidate frequency of 43.1 MHz plus the average of the frequency deviation Freq_Dev at 43.1 MHz will thereby be stored as the WinTone_Freq instead and the power value at 43.1 MHz will be stored as the WinTone_Power to replace the power value at 43 MHz. If one of the criteria checking process at 43.1 MHz fails, WinTone_Freq and WinTone_Power will sustain the values derived at 43 MHz. The process described above will iterate until last sinusoidal frequency 47 MHz is fed and processed. If a winner tone, i.e., the maximum tone within a predetermined frequency range from 43 MHz to 47 MHz, is successively found, the arbitrator 1401 will set WinTone_Freq as the target frequency (i.e., Freq_Hop in FIG. 6) then perform the checking process again. Please note that after the winner tone is found, the thresholds are slightly adjusted for design consideration. For example, considering signal might decay due to Doppler effect or multi-path fading, the power threshold is multiplied by a factor which is less than 1. Besides, since the derived winner tone should be very close to the input signal frequency, the average of the frequency deviation Freq_Dev should be very small, a more stringent threshold is thereby applied. After all the checking processes are passed, a RFE process is also successively finished. If the winner tone cannot be found, the tone arbitrator 1401 will set a default frequency as the target frequency. In this example, a central frequency, i.e., 45 MHz, is adopted as the target frequency.

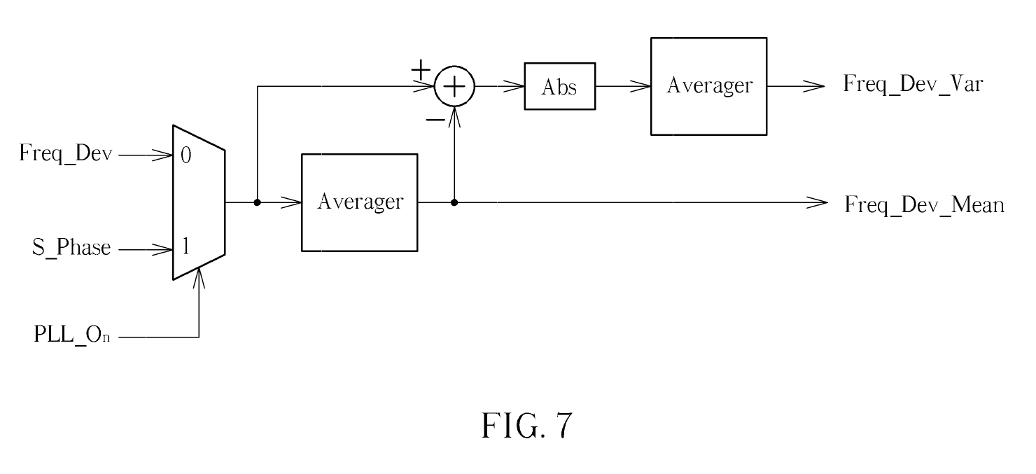

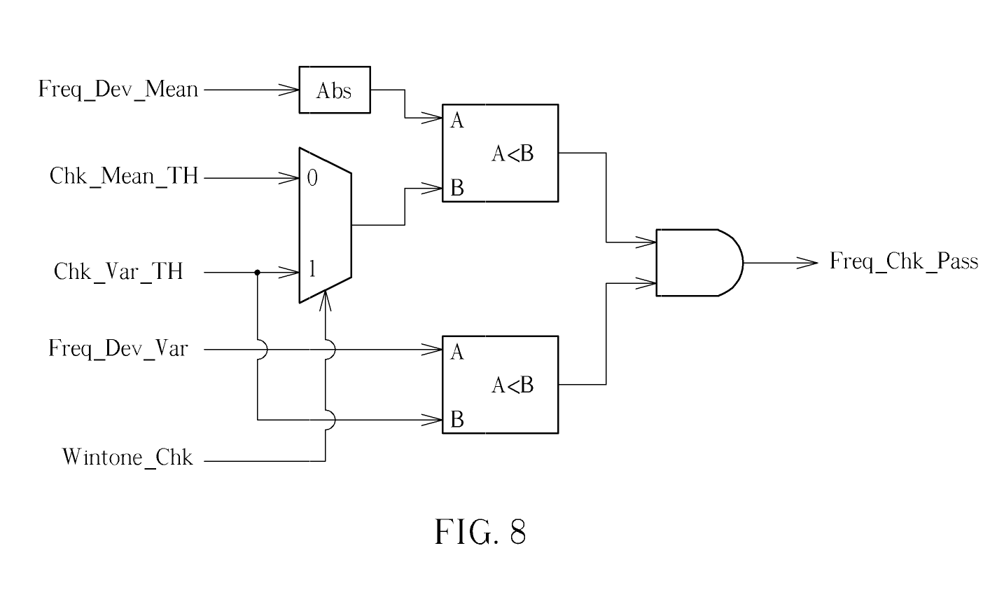

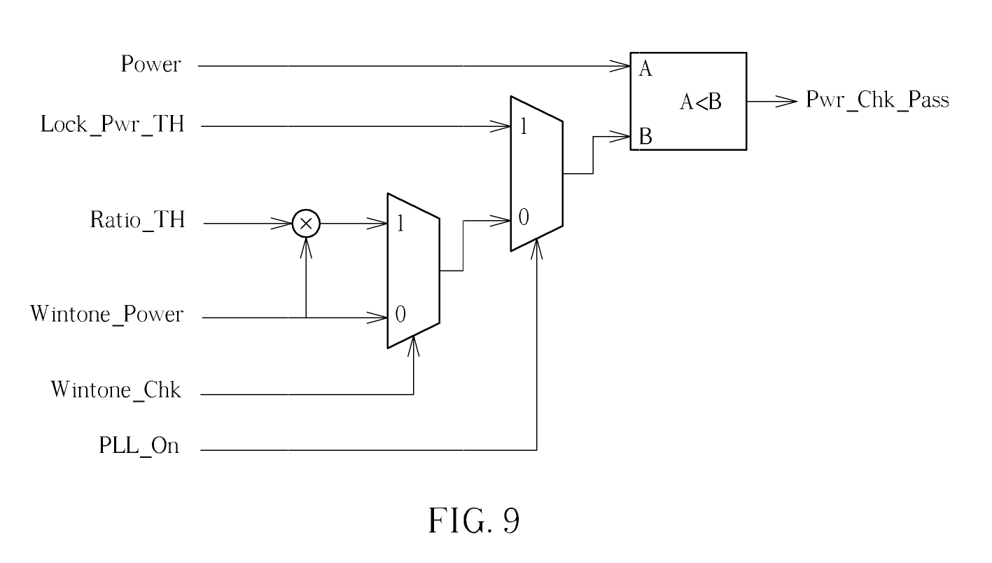

The aforementioned average of the frequency deviation Freq_Dev (i.e., Freq_Dev_Mean in FIG. 7) and variance of the frequency deviation Freq_Dev (i.e., Freq_Dev_Var in FIG. 7) can be derived using an exemplary circuit shown in FIG. 7. In addition, the above-mentioned criterion checking mechanism can be implemented using the exemplary circuits shown in FIG. 8 and FIG. 9, where the checking results Freq_Chk_Pass and Pwr_Chk_Pass indicate whether the estimated power value PV and the frequency deviation Freq_Dev pass or fail the criterion checks. In FIG. 7, FIG. 8 and FIG. 9, PII_On indicates whether the carrier tracking system 100 functions as a PLL or not, and Wintone_Chk indicates that tone arbitrator 1401 is applying the checking process or not. In addition, Chk_Mean_TH and Chk_Var_TH are thresholds set for frequency checking process, Lock_Pwr_TH and Ratio_TH are thresholds set for power checking process. As a person skilled in the art can readily understand operations of the circuitry shown in FIG. 7, FIG. 8, and FIG. 9 after reading the paragraphs above, further description is omitted here for brevity.

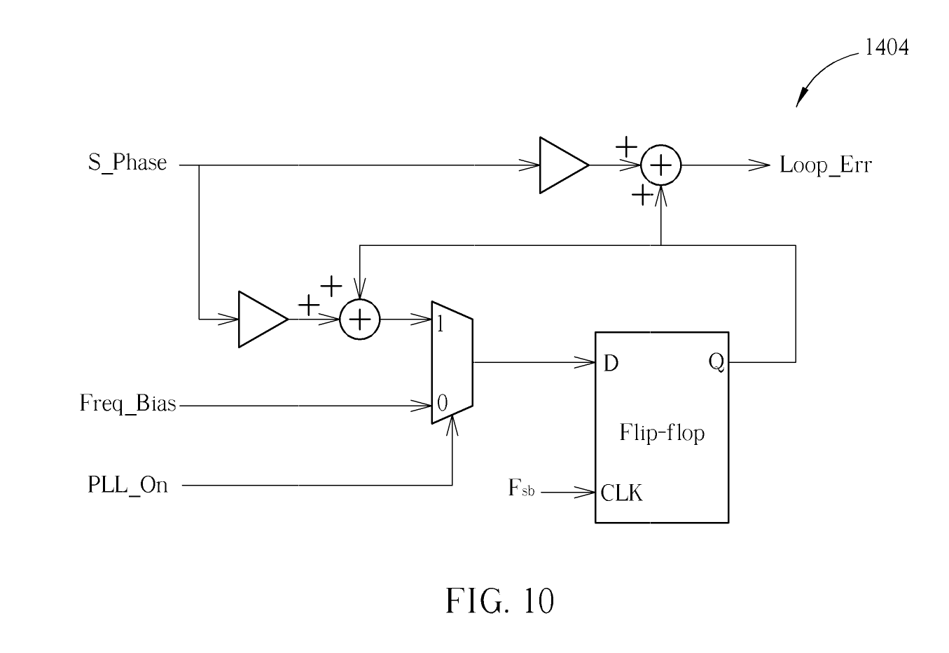

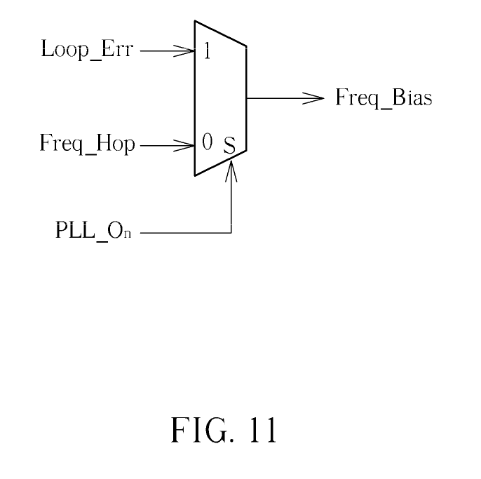

As shown in FIG. 1, the control circuit 140 also has a loop filter 1404 included therein. The loop filter 1404 generates a loop error signal Loop_Err for fine-tuning the frequency bias signal Freq_Bias when the target frequency is determined in the first and the second operation states S1, S2. In the third operation state S3, the tone arbitrator 1401 compensates the target frequency for the frequency bias signal Freq_Bias according to the loop error signal Loop_Err. In more detail, the loop filter 1404 is triggered by the target frequency, and generates the loop error signal Loop_Err according to the phase signal S_Phase. An exemplary implementation of the loop filter 1404 is shown in FIG. 10. Then, the tone arbitrator 1401 generates the frequency bias signal Freq_Bias based on the target frequency and the loop error Loop_Err. As a person skilled in the art can readily understand the operation of the circuitry shown in FIG. 10 and FIG. 11 after reading above description, further description is omitted here for brevity. In addition, the carrier tracking system 100 thereby functions as a PLL to track the input signal S_IN. After the loop acquisition of the carrier tracking system 100 is done and the closed loop is stable. A certain criteria similar to the criteria in the first and the second operation states S1, S2 apply again on the power value PV and the frequency deviation Freq_Dev corresponding to the loop error signal Loop_Err generated from the loop filter 1404 to ensure the input power is locked by the carrier tracking system 100.

In view of disclosure above, the method employed by the carrier tracking system 100 for tracking a tone within a predetermined frequency range can be briefly summarized using following steps: generating a Cartesian signal by mixing an input signal and sine and cosine signals; generating the sine and cosine signals based on a frequency bias signal; converting the Cartesian signal into a polar signal having a norm signal and a phase signal; selecting a candidate frequency within the predetermined frequency range based on the norm signal and a estimated frequency deviation corresponding to the candidate frequency based on the phase signal; and generating the frequency bias signal based on the target frequency (which is generated based on the candidate frequency and the estimated frequency deviation) and a loop error.

In summary, a carrier tracking system and method for tracking a tone within a predetermined frequency range are disclosed. With the help of a coordinate converter, the proposed carrier tracking system and method are capable of estimating a frequency very close to the target frequency quickly and avoiding misjudging a false signal as the target signal by utilizing the RFE process. In this way, tone-like signal (a carrier or a tone) with a maximum power within a predetermined frequency range could be synchronized quickly and accurately, leading to an improvement in the overall system performance.

Those skilled in the art will readily observe that numerous modifications and alterations of the device and method may be made while retaining the teachings of the invention.

What is claimed is:

1. A carrier tracking system, comprising:
a frequency down-converter for generating a Cartesian signal by mixing an input signal and sine and cosine signals;
a waveform generator for generating the sine and cosine signals based on a frequency bias signal;
a coordinate converter for converting the Cartesian signal into a polar signal having a norm signal and a phase signal; and
a control circuit for selecting a candidate frequency within a predetermined frequency range based on the norm signal and a estimated frequency deviation corresponding to the candidate frequency based on the phase signal, and generating the frequency bias signal based on the candidate frequency, the estimated frequency deviation and a loop error determined by the phase signal.

2. The carrier tracking system of claim 1, wherein the control circuit comprises:
a power detector for estimating the power of the input signal at a plurality of candidate frequencies within the predetermined frequency range based on the norm signal;
a frequency discriminator for estimating frequency deviations of the input signal at the plurality of candidate frequencies; and
a tone arbitrator for selecting the candidate frequency at which the maximum power of the input signal is estimated and the frequency deviation corresponding to the candidate frequency at which the maximum power of the input signal is estimated.

3. The carrier tracking system of claim 2, wherein the control circuit further comprises:
a loop filter for generating the loop error based on the phase signal when the candidate frequency at which the maximum power of the input signal is estimated and the frequency deviation corresponding to the candidate frequency at which the maximum power of the input signal is estimated are selected; and
the tone arbitrator for generating the frequency bias signal based on the candidate frequency, the estimated frequency deviation and the loop error.

4. The carrier tracking system of claim 2, wherein the selection of the tone arbitrator is confirmed only when the maximum power exceeds a power threshold and the frequency deviation satisfies predetermined criteria.

5. The carrier tracking system of claim 4, wherein the frequency deviation satisfy that an average of the frequency deviation within a predetermined time period and a variation of the frequency deviation within the predetermined time period do not exceed an average threshold and a variance threshold, respectively.

6. The carrier tracking system of claim 2, wherein the selection of the tone arbitrator is confirmed only when the maximum power exceeds a power threshold.

7. The carrier tracking system of claim 1, wherein the waveform generator is a Numerical Controlled Oscillator.

8. A method for tracking a tone within a predetermined frequency range, comprising:
generating a Cartesian signal by mixing an input signal and sine and cosine signals;
generating the sine and cosine signals based on a frequency bias signal;
converting the Cartesian signal into a polar signal having a norm signal and a phase signal;
selecting a candidate frequency within the predetermined frequency range based on the norm signal and a estimated frequency deviation corresponding to the candidate frequency based on the phase signal; and
generating the frequency bias signal based on the candidate frequency, the estimated frequency deviation and a loop error determined by the phase signal.

9. The method of claim 8, wherein the step of selecting a candidate frequency within the predetermined frequency range based on the norm signal and its estimated frequency deviation based on the phase signal comprises:
estimating the power of the input signal at a plurality of candidate frequencies within the predetermined frequency range based on the norm signal;
estimating frequency deviations of the input signal at the plurality of candidate frequencies; and
selecting the candidate frequency at which the maximum power of the input signal is estimated and the frequency deviation corresponding to the candidate frequency at which the maximum power of the input signal is estimated.

10. The method of claim 9, wherein the loop error is generated based on the phase signal when the candidate frequency at which the maximum power of the input signal is estimated and the frequency deviation corresponding to the candidate frequency at which the maximum power of the input signal is estimated are selected.

11. The method of claim 9, wherein the selections of the candidate frequency and the frequency deviation are confirmed only when the maximum power exceeds a power threshold and the frequency deviation satisfies predetermined criteria.

12. The method of claim 11, wherein the frequency deviation satisfy that an average of the frequency deviation within a predetermined time period and a variation of the frequency deviation within the predetermined time period do not exceed an average threshold and a variance threshold, respectively.

13. The method of claim 9, wherein the selections of the candidate frequency and the frequency deviation are confirmed only when the maximum power exceeds a power threshold.
